(19) United States
(12) Patent Application Publication
(10) Pub. No.: US 2016/0263808 A1
(43) Pub. Date: Sep. 15, 2016

(54) DIRECT DRIVE EXTRUDER WITH A PERMANENT MAGNET SYNCHRONOUS MOTOR

(71) Applicant: Davis-Standard LLC, Pawcatuck, CT (US)

(72) Inventors: Jeffrey S. Bryan, Voluntown, CT (US); John Champney, West Kingston, RI (US)

(73) Assignee: Davis-Standard LLC, Pawcatuck, CT (US)

(21) Appl. No.: 15/068,872

(22) Filed: Mar. 14, 2016

Related U.S. Application Data
(60) Provisional application No. 62/133,025, filed on Mar. 13, 2015.

(51) Int. Cl. B29C 47/08; B29C 47/84; B29C 47/38

(52) U.S. Cl. CPC B29C 47/0805; B29C 47/38; B29C 47/0803; B29C 47/845; F16C 19/364

(57) ABSTRACT

A direct drive extruder apparatus includes an extruder assembly that has an extruder barrel and an extruder screw rotatably disposed in an interior area of the extruder barrel. The apparatus includes a bearing assembly in communication with the extruder assembly. The bearing assembly has a bearing housing which has a thrust bearing mounted therein. The thrust bearing includes an outer ring secured to the bearing housing and an inner ring in rotatable communication with the outer ring, and a plurality of rolling elements disposed between and in rolling engagement with the outer ring and the inner ring. The apparatus includes a sleeve removably coupled to the inner ring and the extruder screw. The apparatus includes a motor assembly that has a permanent magnet synchronous motor positioned therein, the permanent magnet synchronous motor has a rotatable shaft that is removably coupled to the sleeve.

### CROSS REFERENCE TO RELATED APPLICATIONS

This application claims priority to U.S. Provisional Patent Application Ser. No. 62/133,025, entitled “Direct Drive Extruder,” and filed Mar. 13, 2015, the subject matter of which is incorporated herein by reference in its entirety.

### FIELD OF THE INVENTION

This invention relates to a direct drive extruder, and is more particularly directed to a direct drive extruder having a Permanent Magnet Synchronous Motor (PMSM) in communication with the extruder via a thrust bearing.

### BACKGROUND

Extrusion devices are used to melt, blend, and form materials, such as plastics, into a desired shape. Typical extrusion devices include a rotating screw housed coaxially within a heated, cylindrically-shaped feed throat and barrel. A portion of the feed throat is cut away forming an opening for admission of materials. A hopper is coupled to the extrusion device for feeding the material through the opening, into the feed throat and subsequently into the barrel. The screw rotates within the feed throat and barrel and drives the material therethrough. The extrusion material is forced through a die or aperture at a discharge end of the barrel.

In reference to FIGS. 8 and 9, an extruder device 10 is generally designated by the numeral 10. The extruder device 10 includes a drive section 12, a feed section 14 and an extrusion section 16 with the feed section 14 disposed between the drive section 12 and the extrusion section 16. An extruder screw has one end supported by and connected to a drive shaft (not shown) disposed within the drive section 12. The screw is a deep flighted feed screw having channels defined between threads of the screw. The drive section 12 includes a gear box 12A that is driven by a suitable driver (not shown) (e.g., a hydraulic drive system or an A/C induction motor) that rotates gears (not shown) in the gear box 12A, the shaft and the screw (not shown). The screw 18 is also supported in the extrusion section 16 by a suitable bearing (not shown) such as a journal bearing.

While the gear box 12A and A/C induction motor can provide speed control of the extruder screw, the gear box 12A consumes energy and reduces the efficiency of the extruder apparatus. In addition, speed cannot be control precisely with the gear box 12A and A/C induction motor because of the constant speed of the motor and back lash and/or tolerances between gears in the gear box 12A. Furthermore, the gear box 12A is bulky, heavy and expensive to fabricate, assemble, ship and maintain.

Based on the foregoing, it is the general object of this invention to provide an extruder apparatus that is energy efficient and can provide precise speed control for the extruder screw.

### SUMMARY OF THE INVENTION

The present invention resides in a direct drive extruder apparatus that includes an extruder assembly that has an extruder barrel and an extruder screw rotatably disposed in an interior area of the barrel. The apparatus includes a bearing assembly in communication with the extruder assembly. The bearing assembly has a bearing housing which has a thrust bearing mounted therein. The thrust bearing includes an outer ring secured to the bearing housing and an inner ring in rotatable communication with the outer ring, and a plurality rolling elements disposed between and in rolling engagement with the outer ring and the inner ring. The apparatus includes a sleeve removably coupled to the inner ring and the extruder screw. The apparatus includes a motor assembly that has a permanent magnet synchronous motor positioned therein, the permanent magnet synchronous motor has a rotatable shaft that is removably coupled to the sleeve.

In one embodiment the rotatable shaft defines a first bore extending therethrough. In one embodiment, the direct drive extruder apparatus a cooling device extending through the first bore and in communication with a second bore extending at least partially into the extruder screw.

### BRIEF DESCRIPTION OF THE DRAWINGS

FIG. 1 is a front cut away view of the direct drive extruder of the present invention;

FIG. 2 is a cross sectional view of a thrust bearing assembly of the present invention;

FIG. 3 is a perspective view of the thrust bearing assembly of FIG. 2;

FIG. 4A is a cross sectional view of a portion of the direct drive extruder apparatus of FIG. 1 showing a cooling device disposed therein;

FIG. 4B is a cross sectional view of a portion of the direct drive extruder apparatus of FIG. 1 with the cooling device removed and a push-rod disposed therein;

FIG. 5 is a perspective view of a the cooling device of FIG. 4A;

FIG. 6 is a cross sectional view taken across line 6-6 of FIG. 4A;

FIG. 7 is a cross sectional view taken across line 7-7 of FIG. 4A;

FIG. 8 is a perspective view of a single barrel extruder device; and

FIG. 9 is an enlarged perspective view of a portion of the extruder device of FIG. 8.

### DETAILED DESCRIPTION OF THE INVENTION

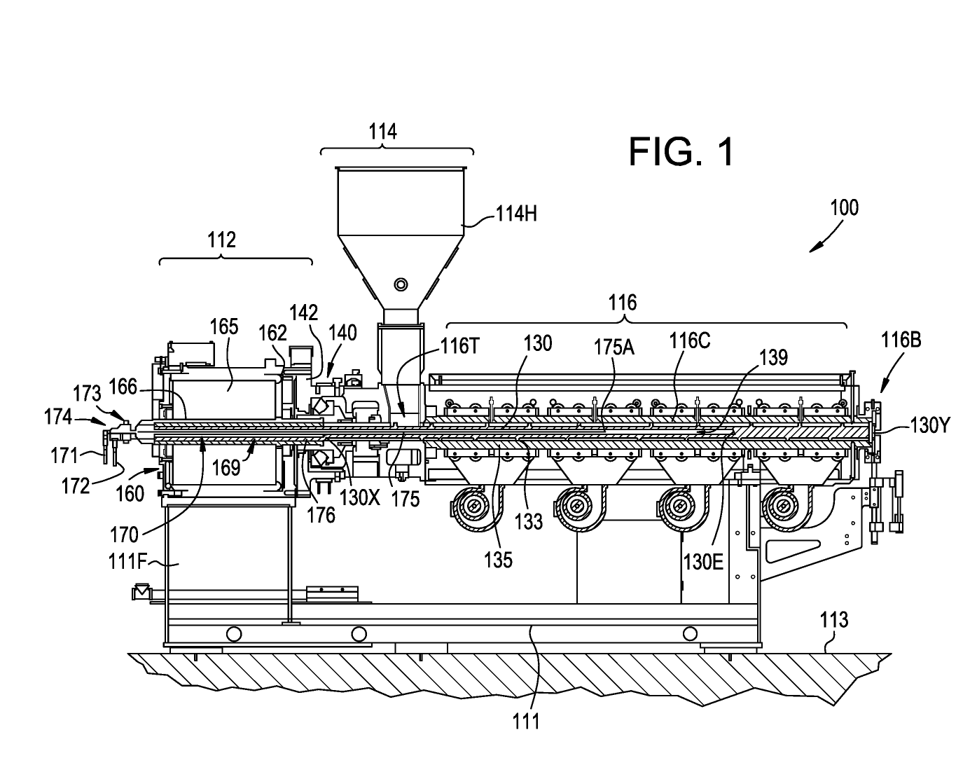

Referring to FIG. 1, a direct drive extruder apparatus, is generally designated by the numeral 100. The direct drive extruder apparatus 100 includes a drive section 112, a feed section 114 and an extrusion section 116 with the feed section 114 disposed between the drive section 112 and the extrusion section 116. The drive section 112 is mounted on a stand 111F and the stand 11F and the extruder section are mounted on a base 111 that is fixedly secured to a foundation 113. An extruder screw 130 extends from a first end 130X into an interior area defined by a barrel 116C of the extruder section 116 and terminates at a second end 130Y thereof. The extruder screw 130 has the second end 130Y rotatably supported by and connected to a portion of a thrust bearing assembly 140 disposed within the drive section 112. The extruder screw 130 is a deep flighted feed screw having flights 133 and channels 135 defined between the flights 133. The screw 130 is also supported in the extrusion section 116 by a suitable bearing 116B such as a roller bearing. The extruder screw 130 is open at the first end 130X and has a bore 139 that extends therethrough and terminates at a closed end portion 130E proximate the second end 130Y of the extruder screw.

Still referring to FIG. 1, the feed section 114 includes a hopper 114H for channeling material such as polymer pellets into a throat section 116T of the extruder 116. The bearing assembly 140 is in communication with the extruder assembly 116 as described herein.

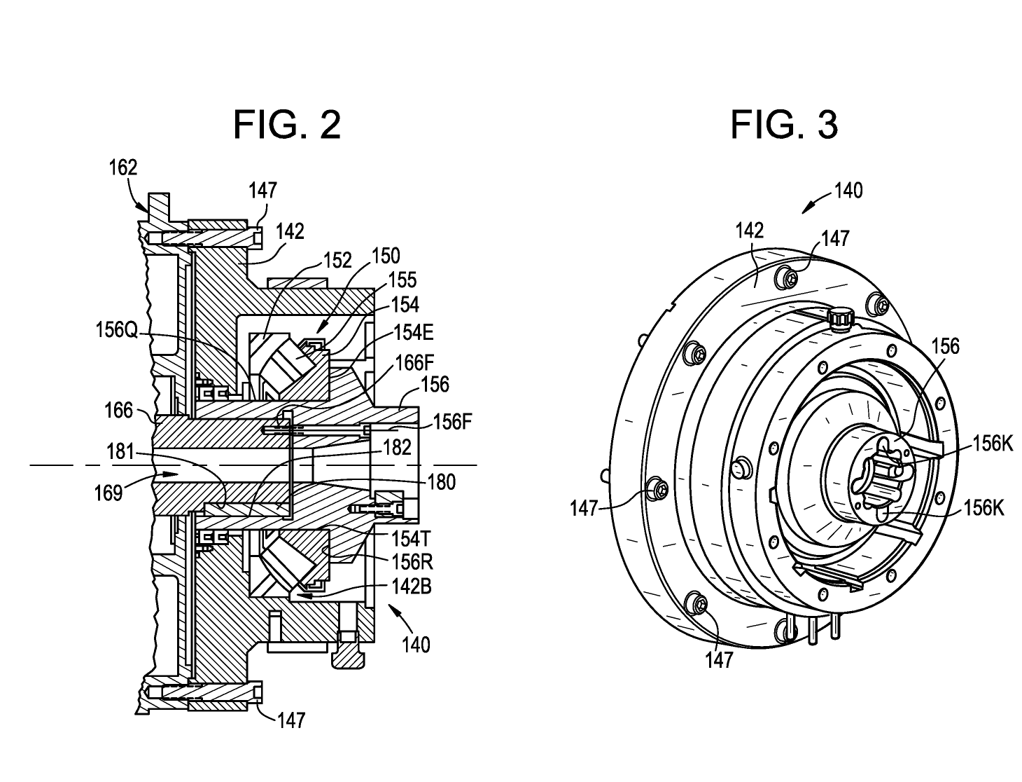

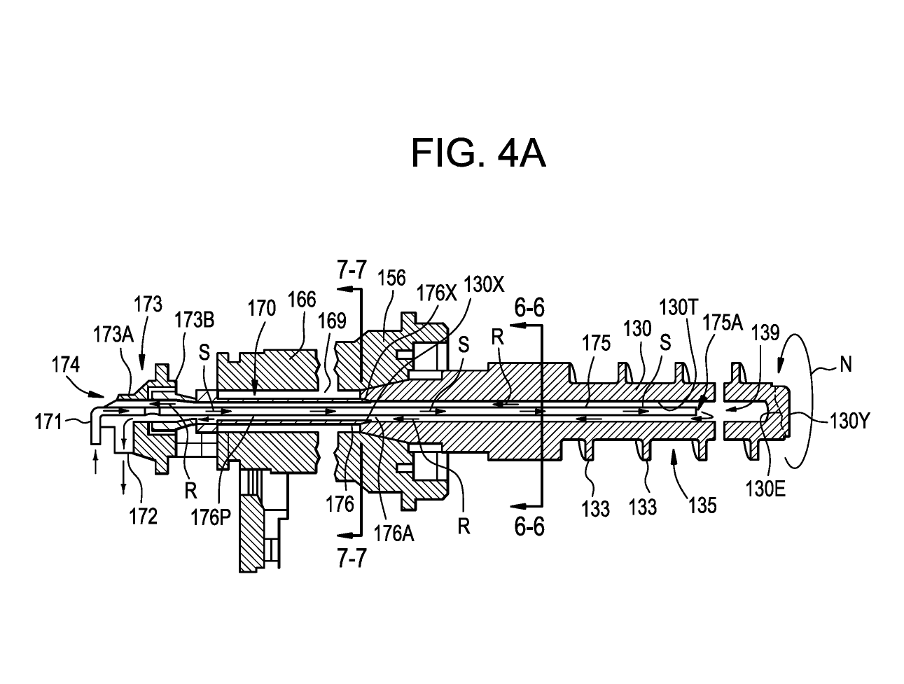

As shown in FIGS. 2 and 3, the bearing assembly 140 includes a bearing housing 142. The bearing housing 142 has a thrust bearing 150 mounted therein. The thrust bearing 150 includes an outer ring 152 secured to the bearing housing 142, for example by press fitting into a bore 142B of the housing. The thrust bearing 150 includes an inner ring 154 in rotatable communication with the outer ring 152. A plurality rolling elements 155 (e.g., barrel shaped rollers or balls) are disposed between and in rolling engagement with the outer ring 152 and the inner ring 154. The inner ring 154 is coupled to a sleeve 156. For example, an interior surface 154T of the inner ring 154 is press fit over an exterior surface 156Q of the sleeve 156 and an axial end 154E of the inner ring 154 abuts a shoulder portion 156R of the sleeve 156. The sleeve 156 includes keyways 156K (e.g., four shown, but not limited to four) to receive a complementarily shaped portion of the first end 130X of the extruder screw 130 so that the rotatable shaft 166, the sleeve 156, the inner ring 154 and the extruder screw 130 rotate together in response to operation of the permanent magnet synchronous motor 165, as described herein. The keyways 156K and the complementarily shaped portion of the first end 130X of the extruder screw 130 prevent relative rotation between the sleeve 156 and the extruder screw 130. While the keyways 156K and the complementarily shaped portion of the first end 130X of the extruder screw 130 are shown and described as preventing relative rotation between the sleeve 156 and the extruder screw 130, the present invention is not limited in this regard as other mechanisms to prevent such relative rotation may be employed, including but not limited to a splined configuration and pin-and-hole arrangements.

As shown in FIG. 1, the direct drive extruder apparatus 100 includes a motor assembly 160 having a motor housing 162 secured to the bearing housing 142, for example with a plurality of fasteners (e.g., bolts) 147 (see FIG. 2). The motor assembly 160 has a permanent magnet synchronous motor 165 positioned therein. The permanent magnet synchronous motor 165 has a rotatable shaft 166 therein. In one embodiment, the rotatable shaft 166 is hollow and defines a first bore 169 (see FIGS. 1 and 2) extending therethrough. In one embodiment, the rotatable shaft 166 is solid. The permanent magnet synchronous motor 165 is a synchronous motor that uses permanent magnets rather than windings in the rotor. Electronic excitation control is provided in the permanent magnet synchronous motor 165 with an integrated power inverter and rectifier, sensor, and inverter electronics (not shown).

As shown in FIG. 2, the rotatable shaft 166 is coupled to the inner ring 154 of the thrust bearing 150, via a key 180 fit into a keyway 181 in the rotatable shaft 166 and a keyway 182 in the sleeve 156. The key 180 and the keyways 181 and 182 prevent relative rotation between the sleeve 156 and the rotatable shaft 166. In addition, the sleeve 156 is axially secured to the rotatable shaft 166 by suitable fasteners 156F. While the key 180 and the keyways 181 and 182 are shown and described as preventing relative rotation between the sleeve 156 and the rotatable shaft 166, the present invention is not limited in this regard as other mechanisms for preventing such relative motion may be employed including but not limited to splined configurations and pin-and-hole arrangements.

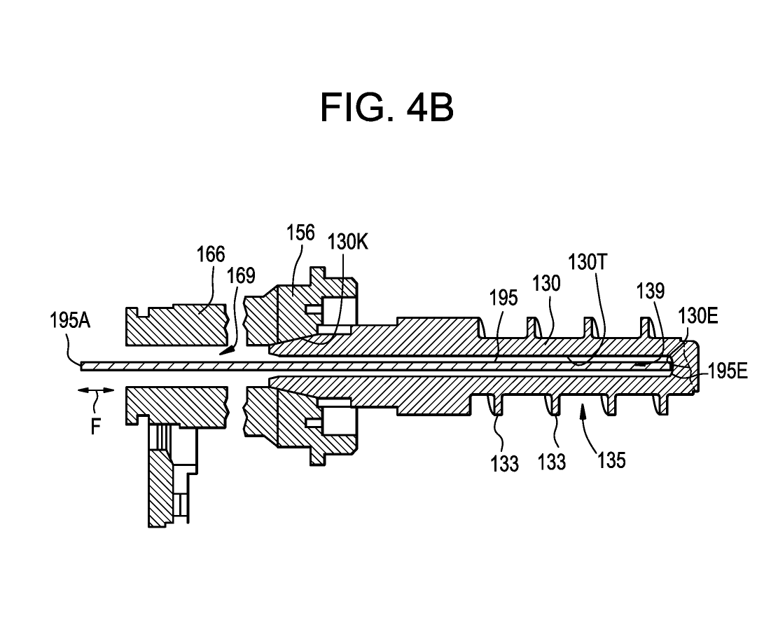

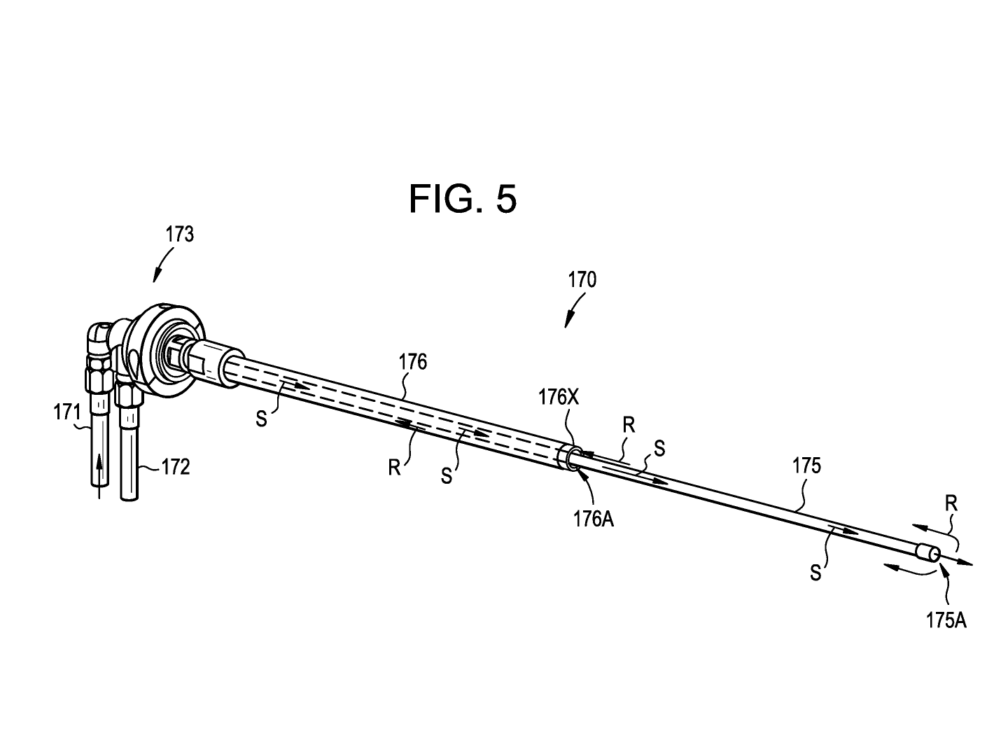

As shown in FIGS. 1, 4A and 5 the direct drive extruder apparatus 100 includes a cooling device 170 extending through the first bore 169 of the rotatable shaft 166 and into the bore 139 of the extruder screw 130. The cooling device 170 has an inlet 171 and an outlet 172 and a rotational coupling 173 (e.g., a two passage rotary union manufactured by Deublin® Co. of Waukegan, IL) proximate a first end 174 thereof. The rotational coupling 173 has a stationary portion 173A that is in fixed relation to the inlet 171 and the outlet 172. The rotational coupling 173 has a rotatable portion 173B that is coupled to and rotates with the rotatable shaft 166 as indicated by the arrow N in FIG. 4A. The rotational coupling 173 has internal seals (not shown) that seal the stationary portion 173A relative to the rotatable portion 173B.

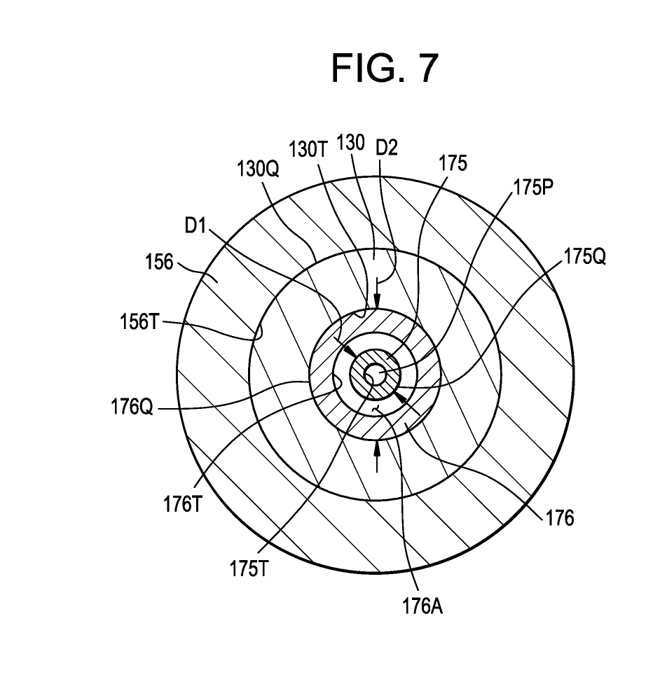

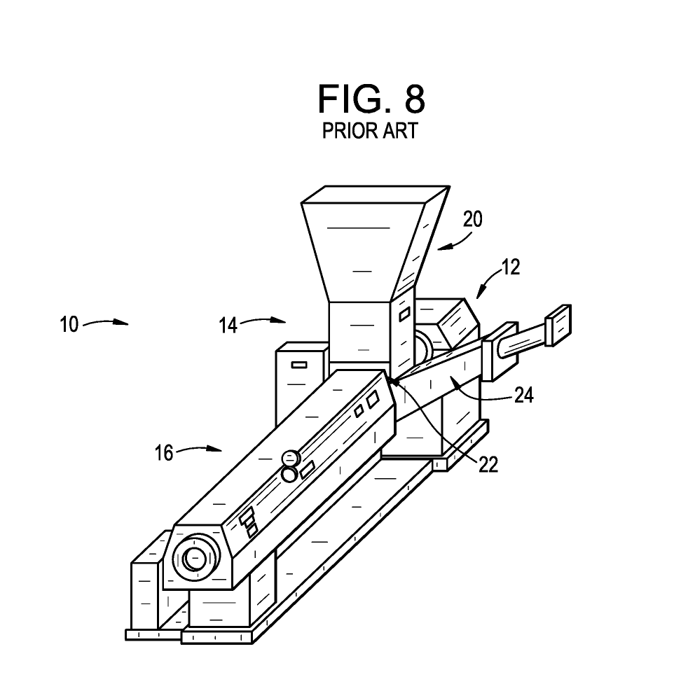

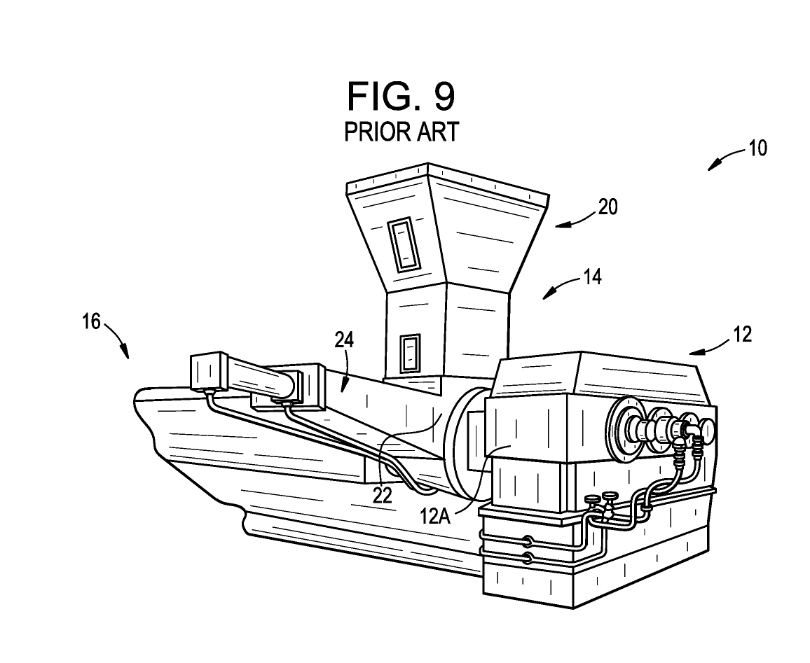

As best shown in FIG. 4A, the cooling device 170 has a feed pipe 175 and a return pipe 176 extending longitudinally from the rotatable portion 173B of the rotational coupling 173. As shown in FIG. 7 the return pipe 176 has a cylindrical interior surface 176T that has an inside diameter D2. The return pipe 176 has an exterior surface 176Q. The feed pipe 175 has a cylindrical exterior surface 175Q that has a diameter D1, which is less than the inside diameter D2 of the return pipe 176. The return pipe 176 extends from the rotational coupling 173 (see FIG. 4A) to a terminal end 176X thereof. The terminal end 176X sealingly engages the first end 130X (see FIG. 4A) of the extruder screw 130. The extruder screw 130 has an exterior surface 130Q a portion of which proximate the first end 130X engages an interior surface 156T of the sleeve 156. The interior surface 176T of the return pipe 176 defines a return flow passage 176P an entrance 176A of which is proximate the terminal end 176X of the return pipe 176 and the first end 130X of the extruder screw 130.

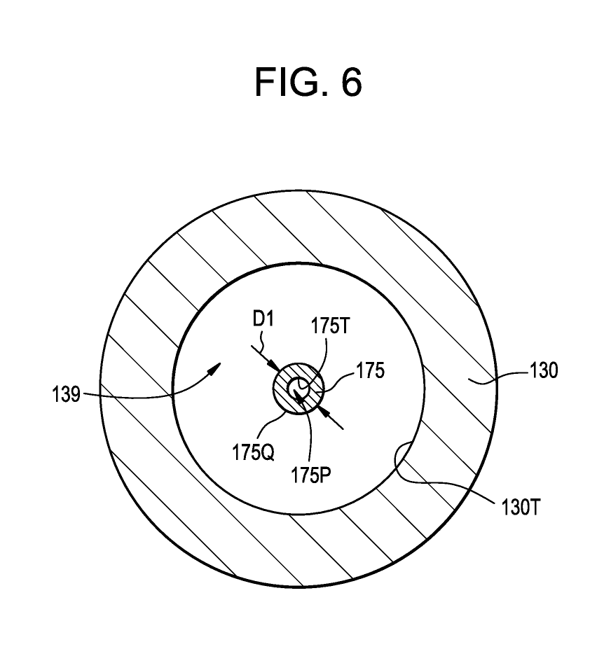

As best shown in FIG. 4A, the feed pipe 175 extends through the flow passage 176P of the return pipe 176, axially outward from the entrance 176A and into the bore 139 of the extruder screw 130. The feed pipe 175 has a discharge end 175A that terminates a predetermined distance from the closed end portion 130E of the extruder screw 130. The feed pipe 175 has an interior surface 175T (see FIGS. 6 and 7) that defines a feed flow passage 175P in the feed pipe 175. The feed pipe 175 is longer than the return pipe 176. The return pipe 176 surrounds (e.g., circumferentially surrounds) a portion of the feed pipe 175 and the feed pipe 175 extends axially outward from the return pipe 176.

During operation, a coolant flows in through the inlet 171, through the rotational coupling 173, through the feed flow passage 175P of the feed pipe 175 and discharges outwardly from the discharge end 175A of the feed pipe 175, as indicated by the arrows S, into the bore 139 of the extruder screw 139. The coolant circulates in the bore 139 thereby cooling the extruder screw 130. Warmed coolant enters the entrance 176A of the return pipe 176, flows through the return flow passage 176P, as indicated by the arrows R, and exits via the outlet 172.

As shown in FIG. 4B, the present invention includes a push-rod 195 that has a first end 195A and a second end 195E. During disassembly, the coolant device 170 is removed from the rotatable shaft 166 and the bore 139 of the extruder screw 130. The push rod 195 is slid in and out of the first bore 169 and the bore 139 of the extruder screw 130 in the direction of the arrow F so that the second end 195E of the push rod forcefully engages the closed end 130E of the extruder screw 130. This operation dislodges the extruder screw 130 from engagement with the sleeve 156 so that that the extruder screw can be removed from the barrel 116C of the extruder apparatus 100.

Although the invention has been described with reference to particular embodiments thereof, it will be understood by one of ordinary skill in the art, upon a reading and understanding of the foregoing disclosure that numerous variations and alterations to the disclosed embodiments will fall within the scope of this invention and of the appended claims.

What is claimed is:

1. A direct drive extruder apparatus, the apparatus comprising:
an extruder assembly defining an extruder barrel and an extruder screw rotatably disposed in an interior area defined by the extruder barrel;
a bearing assembly in communication with the extruder assembly, the bearing assembly having a bearing housing, the bearing housing having a thrust bearing mounted therein, the thrust bearing comprising an outer ring secured to the bearing housing and an inner ring in rotatable communication with the outer ring, and a plurality of rolling elements disposed between and in rolling engagement with the outer ring and the inner ring;
a sleeve removably coupled to the inner ring and the extruder screw; and
a motor assembly having a motor housing secured to the bearing housing, the motor assembly having a permanent magnet synchronous motor positioned therein, the permanent magnet synchronous motor having a rotatable shaft therein, and the rotatable shaft being removably coupled to the sleeve.

2. The apparatus of claim 1, wherein the rotatable shaft defines a first bore extending therethrough.

3. The apparatus of claim 2, further comprising at least one cooling device extending through the first bore and in communication with a second bore extending at least partially into the extruder screw.

4. The apparatus of claim 1, wherein the rotatable shaft is solid.

5. The apparatus of claim 1, wherein an interior surface of the inner ring is press fit over an exterior surface of the sleeve and an axial end of the inner ring abuts a shoulder portion of the sleeve.

6. The apparatus of claim 1, further comprising a first keyway in the rotatable shaft, a second keyway in the sleeve and a key disposed in the first keyway and the second keyway to prevent relative rotation between the sleeve and the rotatable shaft.

7. The apparatus of claim 1, wherein the sleeve is axially secured to the rotatable shaft by suitable fasteners.

8. The apparatus of claim 1, wherein the sleeve includes at least one third keyway and a portion of the extruder screw is formed in a complementary shape to the at least one third keyway to prevent relative rotation between the sleeve and the extruder screw.

9. The apparatus of claim 1, wherein the rotatable shaft, the sleeve, the inner ring and the extruder screw are configured to rotate together in response to operation of the permanent magnet synchronous motor.

10. The apparatus of claim 3, wherein the cooling device comprises a feed pipe and a return pipe.

11. The apparatus of claim 10, wherein the return pipe surrounds a portion of the feed pipe.

12. The apparatus of claim 3, wherein a portion of the cooling device is secured to at least one of the rotatable shaft, the sleeve, and the extruder screw for rotation therewith.

13. The apparatus of claim 3, further comprising a rotational coupling having a stationary portion and a rotatable portion and a portion of the cooling device is secured to the rotatable portion and to at least one of the rotatable shaft, the sleeve, and the extruder screw for rotation therewith.

14. The apparatus of claim 10, wherein the feed pipe extends further into the second bore than does the return pipe.
